(19) United States
(12) Patent Application Publication
(10) Pub. No.: US 2005/0209497 A1
(43) Pub. Date: Sep. 22, 2005

(54) Method for sequenced microstabilization of heavy metal bearing materials and wastes

(76) Inventor: Keith Edward Forrester, Meredith, NH (US)

Correspondence Address: Keith E. Forrester, 78 Tracy Way, Meredith, NH, 03253, US

(21) Appl. No.: 11/079,845

(22) Filed: Mar. 14, 2005

Related U.S. Application Data
(60) Provisional application No. 60/554,829, filed on Mar. 19, 2004.

(51) Int. Cl. B09B 3/00

(52) U.S. Cl. 588/252

(57) ABSTRACT

This invention provides a method for sequenced stabilization and agglomeration of heavy metal bearing materials and wastes subject to acid and water leaching tests or leach conditions by addition of water, stabilizing and agglomeration agents such that leaching and mobility potential is inhibited to desired levels. The resultant material or waste after stabilization is deemed suitable for on-site reuse, off-site reuse or disposal as RCRA non-hazardous waste.

### BACKGROUND OF THE INVENTION

Heavy metal bearing materials and wastes, including lead painted materials, lead painted wastes, lead painted wood combustion ash, plastic media blast residue, sand blast residues, garnet blast residue, coal slag blast residue, foundry dusts, paint residues, electroplating waste sludge, sediments, auto shredder residue, storm-water sediment, manhole sediment, printed circuit board residue, white goods shredder residue, primary smelter slag, secondary smelter slag, smelter dust, lead projectile, casting sand, smelter dross, tank bottom sludge, filter cake, wastewater treatment unit sludge, filter backwash sediments, wire insulation, incinerator bottom ash, incinerator flyash, incinerator combined ash, scrubber residues from air pollution control devices such as cyclones, electrostatic precipitators and bag-house filter bags, contaminated soils, and combinations of materials and wastes identified herein may be deemed “Hazardous Waste” by the United States Environmental Protection Agency (USEPA) pursuant to 40 C.F.R. Part 261 and also deemed hazardous under similar regulations in other countries such as Japan, Switzerland, Mexico, Australia, Canada, Taiwan, European Countries, India, and China, and deemed special waste within specific regions or states within those countries, if containing designated leachate solution-soluble and/or sub-micron filter-passing particle sized heavy metals above levels deemed hazardous by those country, regional or state regulators.

In the United States, any solid waste or contaminated soil can be defined as Hazardous Waste either because it is “listed” in 40 C.F.R., Part 261 Subpart D, federal regulations adopted pursuant to the Resource Conservation and Recovery Act (RCRA), or because it exhibits one or more of the characteristics of a Hazardous Waste as defined in 40 C.F.R. Part 261, Subpart C. The hazard characteristics defined under 40 CFR Part 261 are: (1) ignitability, (2) corrosive, (3) reactivity, and (4) toxicity as tested under the Toxicity Characteristic Leaching Procedure (TCLP). 40 C.F.R., Part 261.24(a), contains a list of heavy metals and their associated maximum allowable concentrations. If a heavy metal, such as lead, exceeds its maximum allowable concentration from a solid waste, when tested using the TCLP analysis as specified at 40 C.F.R. Part 261 Appendix 2, then the solid waste is classified as RCRA Hazardous Waste. The USEPA TCLP test uses a dilute acetic acid either in de-ionized water (TCLP fluid 2) or in de-ionized water with a sodium hydroxide buffer (TCLP fluid 1). Both extract methods attempt to simulate the leachate character from a decomposing trash landfill in which the solid waste being tested for is assumed to be disposed in and thus subject to rainwater and decomposing organic matter leachate combination . . . or an acetic acid leaching condition. Waste containing leachable heavy metals is currently classified as hazardous waste due to the toxicity characteristic, if the level of TCLP analysis is above 0.2 to 100 milligrams per liter (mg/L) or parts per millions (ppm) for specific heavy metals. The TCLP test is designed to simulate a worst-case leaching situation . . . that is a leaching environment typically found in the interior of an actively degrading municipal landfill. Such landfills normally are slightly acidic with a pH of approximately 5±0.5. Countries outside of the US also use the TCLP test as a measure of leaching such as Thailand, Taiwan, Mexico, and Canada. Thailand also limits solubility of Cu and Zn, as these are metals of concern to Thailand groundwater. Switzerland and Japan regulate management of solid wastes by measuring heavy metals and salts as tested by a sequential leaching method using carbonated water simulating rainwater and de-ionized water sequential testing. Additionally, U.S. EPA land disposal restrictions prohibit the land disposal of solid waste leaching in excess of maximum allowable concentrations upon performance of the TCLP analysis. The land disposal regulations require that hazardous wastes are treated until the heavy metals do not leach at levels from the solid waste at levels above the maximum allowable concentrations prior to placement in a surface impoundment, waste pile, landfill or other land disposal unit as defined in 40 C.F.R. 260.10.

Suitable acetic acid leach tests include the USEPA SW-846 Manual described Toxicity Characteristic Leaching Procedure (TCLP) and Extraction Procedure Toxicity Test (EP Tox) now used in Canada. Briefly, in a TCLP test, 100 grams of waste are tumbled with 2000 ml of dilute and buffered or non-buffered acetic acid for 18 hours and then filtered through a 0.75 micron filter prior to nitric acid digestion and final ICP analyses for total “soluble” metals. The TCLP test as defined actually measures true solution metals plus particles that pass 0.75 micron filtering and are subsequently digested into solution by nitric acid. The TCLP fluid 1 extraction solution is made up from 5.7 ml of glacial acetic acid and 64.3 ml of 1.0 normal sodium hydroxide up to 1000 ml dilution with reagent water. TCLP fluid 2 is 5.7 ml of glacial acetic acid with DI reagent water up to 1000 ml.

Suitable water leach tests include the Japanese leach test which tumbles 50 grams of composited waste sample in 500 ml of water for 6 hours held at pH 5.8 to 6.3, followed by centrifuge and 0.45 micron filtration prior to analyses. Another suitable distilled water CO₂ saturated method is the Swiss protocol using 100 grams of cemented waste at 1 cm³ in two (2) sequential water baths of 2000 ml. The concentration of heavy metals and salts are measured for each bath and averaged together before comparison to the Swiss criteria.

Suitable citric acid leach tests include the California Waste Extraction Test (WET), which is described in Title 22, Section 66700, “Environmental Health” of the California Health & Safety Code. Briefly, in a WET test, 50 grams of waste are tumbled in a 1000 ml tumbler with 500 grams of sodium citrate solution for a period of 48 hours. The concentration of leached metals are then analyzed by Inductively-Coupled Plasma (ICP) after filtration of a 100 ml aliquot from the tumbler through a 45 micron glass bead filter.

Heavy metals are also regulated in numerous countries as to their content in air, water, wastewater and soils. Limits for allowable “total” metals in air, water, wastewater and soils are established for the primary intent of protecting receptors such as inhalation to humans, ingestion by humans and biological community and toxicity to receptors, flora and ecological communities. Release of heavy metals by means other than true solution in leachate (such as sub-micron or larger particulate transport to sensitive receptors) can remain a concern even if the small particle sized heavy metal is not determined “hazardous” under solubility tests. A lime (CaO) treated refuse incinerator ash, for example, could pass TCLP leach testing if the final TCLP leach pH level was targeted to 9.0 units, yet this lime treated ash particulate would remain highly fugitive and exist in a toxic form as PbO or Pb3O5 . . . which is highly soluble in rainwater, de-ionized water, human and animal stomach acid (dilute HCl), and thus readily transferred to the environment and blood serum.

Of specific interest regarding the present invention is the need to provide a cost-effective means of reducing TCLP and regulatory extraction test-soluble metals while in addition and concurrently controlling field soluble, particle and sub-micron particle release and transport of heavy metals such as Pb, Ba, Ag, Se, Cd, Cr, As, Hg, Cu, Sb, Zn and combined heavy metal groups, into ground-water, air and surface water such as open industrial sites, waste storage cells, waste piles, waste mono-fills.

The present invention provides an optimal sequenced wet water extraction and stabilization/agglomeration method for reducing both the TCLP and regulatory solubility of metals while also reducing actual field potential solubility, sub-micron and particle transport of heavy metal bearing wastes and waste particle size, thus reducing subsequent fugitivity potential, ingestion potential and environmental release potentials. Heavy metals As, Ag, As, Ba, Cd, Cr, Pb, Hg, Se, Cu, Sb, Zn, and combinations thereof are controlled by the invention under TCLP, SPLP, CALWET, MEP, rainwater and surface water leaching conditions as well as under regulatory water extraction test conditions as defined by waste control regulations in Thailand, Taiwan, Japan, Canada, Mexico, Switzerland, Germany, Sweden, The Netherlands and under American Nuclear Standards for sequential leaching of wastes by de-ionized water.

Unlike the present invention, prior art has focused on reducing the regulatory measured solubility of heavy metals under simulated landfill leaching conditions such as TCLP and thus limiting costs associated with managing such wastes as hazardous, by addition of either wet or dry stabilizers (with no or limited hydration to the waste or material) such as phosphates, lime, cement, and sulfides directly to solid waste. These previous methods rely primarily upon seeding the solid waste with sufficient stabilizer such that when the seeded waste is sampled for compliance, that a sufficient amount of stabilizer is present in the extraction vessel along with the waste to precipitate heavy metals out of solution to less than soluble regulatory limits. The prior art provides for metal acetates, metal oxides and more soluble minerals, such as lead acetate, to form in the initial stages of mixing within the TCLP test or other regulatory extraction test, concurrently or prior to the formation of the target stabilized mineral forms which incorporate the stabilizer seed. Consequently there exists an inherent inefficiency in the prior art methods due to either precipitation of non-target more soluble heavy metal minerals and complexes within the regulatory extraction test. Prior art methods also fail to consider the importance of reducing particle transport potential and particle size in combination with reduction of heavy metal solubility. The present invention provides improved means for soluble and sub-micron heavy metal particle precipitation and agglomeration by substantial addition of water as a metals solubility and surface exposure agent followed by precipitation and agglomeration agent addition to this newly formed semi-aqueous wastewater environment, thus reducing both regulatory leaching and particle transport of heavy metals in a wet environment that favors metals precipitation and agglomeration.

U.S. Pat. No. 5,202,033 describes an in-situ method for decreasing Pb TCLP leaching from solid waste using a combination of solid waste additives and additional pH controlling agents from the source of phosphate, carbonate, and sulfates.

U.S. Pat. No. 5,037,479 discloses a method for treating highly hazardous waste containing unacceptable levels of TCLP Pb such as lead by mixing the solid waste with a buffering agent selected from the group consisting of magnesium oxide, magnesium hydroxide, reactive calcium carbonates and reactive magnesium carbonates with an additional agent which is either an acid or salt containing an anion from the group consisting of Triple Superphosphate (TSP), ammonium phosphate, diammonium phosphate, phosphoric acid, boric acid and metallic iron.

U.S. Pat. No. 4,889,640 discloses a method and mixture from treating TCLP hazardous lead by mixing the solid waste with an agent selected from the group consisting of reactive calcium carbonate, reactive magnesium carbonate and reactive calcium magnesium carbonate.

U.S. Pat. No. 4,652,381 discloses a process for treating industrial wastewater contaminated with battery plant waste, such as sulfuric acid and heavy metals by treating the wastewater with calcium carbonate, calcium sulfate, calcium hydroxide to complete a separation of the heavy metals. However, this is not for use in a solid waste situation.

### SUMMARY OF THE INVENTION

The present invention discloses a heavy metal bearing material, waste, or contaminated soil stabilization method through contact of material or waste with water first at levels to induce solubility and release of heavy metals into a wet matrix solution followed by addition of stabilizing and sub-micron particle agglomeration agents and methods of application including chemical addition sequence, induced mixing energy, reaction time hold, water content, Portland Cement, cement kiln dust, lime kiln dust, polymers, lime, magnesium, magnesium oxides, dolomitic lime, ferrous sulfate, ferric chloride, alum, coagulants, flocculants, sulfides, sulfates, phosphates, iron, chlorides, silicates, and combinations thereof which are properly chosen to complement the material or waste constituency and desired material or waste handling characteristics as well as to create a wet environment which favors aqueous heavy metal precipitation and agglomeration reactions. The stabilizing and agglomeration agents proven effective are provided in both in dry and wet chemical form, and thus can be contacted with heavy metal bearing material, waste or contaminated soil and water matrix either prior to waste production such as in-stream at wastewater facilities producing sludge or prior to release of material or waste from dump screws after air pollution control and ash collection devices, or after waste production in waste collection devices or in waste mixing piles.

It is anticipated that the water addition and water metals extraction step and subsequent stabilizer and agglomeration agents addition can be used for both reactive compliance and remedial actions as well as proactive heavy metals leaching reduction means such that generated wastes or materials from wastewater facilities, furnaces, smelters, shredders, incinerators and other facilities do not exceed hazardous waste criteria. The preferred method of application of water extraction and stabilizer and agglomeration agents would be in-line within the property and facility generating the heavy metal bearing material, and thus allowed under USEPA regulations (RCRA) as totally enclosed, in-tank or exempt method of TCLP stabilization without the need for a RCRA Part B hazardous waste treatment and storage facility permit. The preferred form of stabilizer and agglomeration agent application would first incorporate sufficient water content and contact time to allow for heavy metals to form solution and fine suspension within the water matrix thus providing for optimal metals solution precipitation and agglomeration either as a flocculation of suspension agglomeration. Optimization of metals solution and fine particle formation in solution and subsequent precipitation and agglomeration may also employ controlled mixing, reaction and product formation duration holding times, and other methods as may be found to induce metals release and solubility thus allowing increased aqueous precipitate recovery.

### DETAILED DESCRIPTION

Environmental regulations throughout the world such as those developed by the USEPA under RCRA and CERCLA require heavy metal bearing waste, contaminated soils and material producers to manage such materials and wastes in a manner safe to the environment and protective of human health. In response to these regulations, environmental engineers and scientists have developed numerous means to control heavy metals solubility, mostly through chemical applications which convert the solubility of the material and waste character to a less soluble form either before or during the extraction test procedure(s), thus passing leach tests which measure for solubility after extraction methods and allowing the wastes to be either reused on-site or disposed at local landfills without further and more expensive control means such as hazardous waste disposal landfills or facilities designed to provide metals stabilization. The primary focus of scientists has been on reducing solubility of heavy metals such as lead, cadmium, chromium, arsenic and mercury, as these were and continue to be the most significant mass of metals contamination in soils. Materials such as paints, incinerator ash, smelter dust, shredder fluff, firing range soils, wire insulation, and cleanup site wastes such as battery acid in soils, mining waste tailings and slag wastes from smelters are some examples of major lead contamination sources.

There exists a demand for improved control methods of heavy metals from industrial and commercial waste streams and at remedial sites an a concurrent need to reduce small and sub-micron particle transport potential from stabilized waste disposal and reuse sites where solubility is controlled but particle transport is possible.

The present invention discloses a heavy metal bearing material, waste, or contaminated soil water extraction and sequenced stabilization and agglomeration and small to sub-micron particle control method through contact of material, waste, or contaminated soil with sufficient water to induce target metals solubility and particle release from the material, waste or contaminated soil, into wetted void spaces and onto wetted particle surfaces followed by introduction of stabilizing agents and agglomeration agents (and methods of application including reaction holding time and mixing energy) including water, Portland Cement, cement kiln dust, lime kiln dust, polymers, lime, magnesium, magnesium oxides, dolomitic lime, ferrous sulfate, ferric chloride, alum, coagulants, flocculants, sulfides, sulfates, phosphates, iron, chlorides, silicates, and combinations thereof. The stabilizing and agglomeration agents found effective are available in dry, slurry and wet chemical form, and thus can be contacted with wetted heavy metal bearing material prior to waste generation such as in-stream at wastewater sludge producing plants or in-screw or in-tank after air pollution control and ash collection devices or after waste production in collection devices such as hoppers, dump valves, conveyors, dumpsters or waste piles.

It is anticipated that the stabilizers can be used for RCRA compliance actions such that generated materials from wastewater facilities, furnaces, incinerators and other facilities do not exceed appropriate TCLP hazardous waste criteria, and under TCLP or CERCLA (Superfund) response where stabilizers are added to waste piles or storage vessels previously generated. The preferred method of application of stabilizers would be in-line within the property and facility generating the heavy metal bearing material, and thus allowed under RCRA as a totally enclosed, in-tank or exempt method of TCLP stabilization without the need for a RCRA Part B hazardous waste treatment and storage facility permit(s).

The stabilizing and sub-micron particle agglomeration agents including water, Portland Cement, cement kiln dust, lime kiln dust, polymers, lime, magnesium, magnesium oxides, dolomitic lime, ferrous sulfate, ferric chloride, alum, coagulants, flocculants, sulfides, sulfates, phosphates, iron, chlorides, silicates, and combinations thereof, with the phosphate group including but not limited to wet process amber phosphoric acid, wet process green phosphoric acid, aluminum finishing Coproduct blends of phosphoric acid and sulfuric acid, technical grade phosphoric acid, monoammonia phosphate (MAP), diammonium phosphate (DAP), single superphosphate (SSP), triple superphosphate (TSP), hexametaphosphate (HMP), tetrapotassium polyphosphate, dicalcium phosphate, tricalcium phosphate, monocalcium phosphate, phosphate rock, pulverized forms of all above dry phosphates, and combinations thereof would be selected through laboratory treatability and/or bench scale testing to provide sufficient control of metals solubility and particle transport potential. In certain cases, such as with the use of amber and green phosphoric acid acid, phosphates may embody sulfuric acid, vanadium, iron, aluminum and other complexing agents which could also provide for a single-step formation of complexed heavy metal minerals. The stabilizer and agglomeration agent type, size, dose rate, contact duration, and application means would be engineered for each type of heavy metal bearing material, soil or waste.

Although the exact stabilization formations are mostly undetermined at this time, it is expected that when heavy metals comes into contact with the stabilizing and agglomeration agents in the presence of water and sufficient reaction time and energy, low fugitive low TCLP/water soluble compounds form in the aqueous matrix newly produced by water addition such as a lead phosphate, mineral phosphate, twinned mineral, mononuclear silicate layers or precipitate through substitution or surface bonding, which is less soluble than the heavy metal element or molecule originally in the material, waste or contaminated soil. It also remains possible that additional process modifications to temperature and pressure may accelerate of assist formation of certain minerals, although such methods are not considered optimal for this application given the need to limit cost and provide for optional field-based stabilizing operations at STP that would be complicated by the need for pressure and temperature control devices and vessels. For example, ambient water has been observed to provide stabilization and agglomeration for lead TCLP solubility in trash incinerator flyash-scrubber products, with additional reduction in lead TCLP solubility by addition of phosphates, cement, curing time and combinations thereof.

In another method, heavy metal bearing material, waste or contaminated soil is contacted with at least one phosphate selected from the phosphate group in the presence of sufficient water to create saturated waste conditions and agglomeration agent such as cement selected to generate a material or waste which cures and solidifies to reduce subsequent fugitivity and surface particle release potential.

Examples of suitable stabilizing and agglomeration agents include, but are not limited to, water, Portland cement, alum, sulfates, sulfides, ferric chloride, phosphate fertilizers, phosphate rock, pulverized phosphate rock, calcium orthophosphates, monocalcium phosphate, dicalcium phosphate, tricalcium phosphate, trisodium phosphates, calcium oxide (quicklime), dolomitic quicklime, silicates, sodium silicates, potassium silicates, natural phosphates, phosphoric acids, wet process green phosphoric acid, wet process amber phosphoric acid, black phosphoric acid, merchant grade phosphoric acid, aluminum finishing phosphoric and sulfuric acid solution, hypophosphoric acid, metaphosphoric acid, hexametaphosphate, tertrapotassium polyphosphate, polyphosphates, trisodium phosphates, pyrophosphoric acid, fishbone phosphate, animal bone phosphate, herring meal, bone meal, phosphorites, and combinations thereof. Salts of phosphoric acid can be used and are preferably alkali metal salts such as, but not limited to, trisodium phosphate, dicalcium phosphate, disodium hydrogen phosphate, sodium dihydrogen phosphate, tripotassium phosphate, dipotassium hydrogen phosphate, potassium dihydrogen phosphate, trilithium phosphate, dilithium hydrogen phosphate, lithium dihydrogen phosphate or mixtures thereof.

The amounts of water, water reaction and contact time, water mixing energy to induce metals solubility and particle release into the water borne void spaces, and stabilizing and agglomeration agent used, according to the method of invention, depend on various factors including desired solubility reduction potential, desired mineral toxicity, fugitivity control needs, waste disposal limitations on bearing strength, curing time allowance, and desired mineral formation relating to toxicological and site environmental control objectives. It has been found that a sequence of 100% dwb water addition with 60 seconds of low energy mixing followed by 2% dwb amber wet process phosphoric acid with 60 seconds of low energy mixing followed by 10% dwb Portland cement with 60 seconds of low energy mixing for Pb bearing incinerator flyash/scrubber residue and cured 24 hours . . . and 100% dwb water with 60 seconds of low energy mixing followed by 10% dwb triple superphosphate pulverized with 60 seconds of low energy mixing followed by 10% dwb Portland cement by weight of Pb bearing incinerator ash with 60 seconds of low energy mixing and cured 14 days, are sufficient for initial TCLP Pb stabilization to less than RCRA 5.0 ppm limit while providing an initial mixing saturate condition for total dust control of the flyash/scrubber product and producing a fully stabilized and wetted ash product suitable for land disposal without expensive truck tarp covers and landfill disposal dust control measures. However, the foregoing is not intended to preclude yet higher or lower usage of stabilizing or agglomeration agent or combinations if needed since it has been demonstrated that amounts greater than 10% cement and 2% phosphate by weight also work, but are more costly. It has also been demonstrated that amounts less than 100% water with various amounts of cement and less phosphates also meet TCLP levels less than 5.0 ppm during various curing durations.

It is predicted that prior art methods using introduction of dry or wet stabilizers and agglomeration agents to material, waste or contaminated soils prior to sufficient water extraction and saturation, provides for zones of metals mineral formation and non-target mineral formations which consume or bind the stabilization and agglomeration agents to form within that “dry” contact zone. For example, addition of phosphates as phosphoric acid to lime bearing flyash and scrubber residue would form lead phosphates and calcium phosphates with the zones of contact, as well as bind PO4 into physical ash cells, thus limiting PO4 contact with Pb from non-zone ash upon introduction of the entire ash dry treated sample to the regulatory leach test. In the case of TCLP fluid 2 used for scrubber residues in the US, Taiwan, Canada, and Mexico, the untreated ash Pb zones would first be exposed to an acetic acid solution and likely form lead acetate, which has a lower potential of forming lead phosphate thereafter in solution during the TCLP test period.

The examples below are merely illustrative of this invention and are not intended to limit it thereby in any way.

### EXAMPLE 1

In this example Thailand wastewater industrial dewatered sludge (34% water as received) was stabilized with varying amounts of stabilizing and agglomeration agents including first introduction of water (H) to induce solution and release of metals, followed by addition of stabilization and agglomeration agents amber phosphoric acid (WAA), and Portland cement type A/B (PC) at 24 hour curing time. Both stabilized and un-stabilized sludge samples were subsequently tested for TCLP Total Pb (includes soluble lead and all particle lead passing 0.75 micron filter) and TCLP Soluble Pb (includes soluble lead and all particle lead passing 0.05 micron filter). Samples were extracted according to TCLP procedure set forth in Federal Register, Vol. 55, No. 126, pp. 26985-26998 (Jun. 29, 199), which is hereby incorporated by reference. The leachate was digested prior to analysis by ICP. Sludge prior to stabilization was semi-wet particles. Sludge after stabilization and before 24 hours curing was liquid and somewhat agglomerated. Cement and cement combination stabilized sludge after curing was semi-solid.

TABLE 1

| Stabilizer Dose (%) | TCLP Pb Total/Soluble (ppm) |
|---|---|
| 0 | 45.0/43.2 |
| 20 H | 39.9/38.1 |
| 20 H + 10 PC | 1.3/1.27 |
| 20 H + 10 PC + 1 WAA | <0.05/<0.05 |
| 1 WAA + 10 PC | 5.4/5.2 |

### EXAMPLE 2

In this example Taiwan waste incinerator flyash/scrubber ash residue was stabilized with varying amounts of water (H) first to induce solution and small particle release of metals into the water matrix, followed by stabilization and agglomeration agents triple superphosphate (TSP), dicalcium phosphate (DCP), amber phosphoric acid (WA), and Portland cement type A/B (PC) with various sample curing pre-extraction. Both stabilized and un-stabilized ash was subsequently tested for TCLP leachable Pb. Samples were extracted according to the USEPA TCLP procedure. The leachate was digested prior to analysis by ICP. Ash sample prior to stabilization and agglomeration was free flowing and highly fugitive, maintaining the ability to atomize without mixing upon opening sample containers. Ash immediately after stabilization was non-free flowing, paste-like, non-dusting and with immediate exothermic heat release and soft hardening nature. Cement and cement combination stabilized ash samples after 24 hours open air curing was semi-solid and at an unconfined strength of approximately 30 psi. The importance of introducing water first to create the optimal environment for metals solution and subsequent stabilization is clearly presented when comparing the results of 100 percent water added prior to and after 3 percent phosphoric acid agent. The water addition prior to agent stabilization produced lead reduction to 2.50 ppm as compared to 6.60 ppm when phosphoric acid was added to the flyash-scrubber ash prior to water.

TABLE 2

| Stabilizer Dose (%) | TCLP Pb Total/Soluble (ppm) |
|---|---|
| 0 | 100/98 |
| 100 H + 24 hr | 34/32.5 |
| 30 H + 10 TSP + 15 PC + 24 hr | 12/11.8 |
| 30 H + 10 TSP + 15 PC + 14 day | 0.03/0.03 |
| 30 H + 10 DCP + 15 PC + 24 hr | 46/45.6 |
| 100 H + 10 WA + 15 PC + 24 hr | 0.05/0.05 |
| 3 WA + 100 H + 24 hr | 6.6 |
| 100 H + 1 WA + 24 hr | 28.0 |
| 100 H + 2 WA + 24 hr | 8.40 |
| 100 H + 3 WA + 24 hr | 2.50 |
| 100 H + 1 WA + 10 PC + 24 hr | 14.0 |
| 100 H + 2 WA + 10 PC + 24 hr | 5.9 |

### EXAMPLE 3

In this example Canadian waste incinerator flyash/scrubber ash residue was stabilized with varying amounts of water (H) first to induce solution and small particle release of metals into the water matrix, followed by stabilization and agglomeration agents triple superphosphate (TSP), amber phosphoric acid (WA), and Portland cement type A/B (PC) with various sample curing pre-extraction. Both stabilized and un-stabilized ash was subsequently tested for TCLP leachable Pb. Samples were extracted according to the USEPA TCLP procedure. The leachate was digested prior to analysis by ICP. Ash sample prior to stabilization and agglomeration was free flowing and highly fugitive, maintaining the ability to atomize without mixing upon opening sample containers. Ash immediately after stabilization was non-free flowing, paste-like, non-dusting and with immediate exothermic heat release and soft hardening nature. Cement and cement combination stabilized ash samples after 24 hours open air curing was semi-solid and at an unconfined strength of approximately 30 psi. The importance of introducing water first to create the optimal environment for metals solution and subsequent stabilization is clearly presented when comparing the results of 100 percent water added prior to and after 3 percent phosphoric acid agent. The water addition prior to agent stabilization produced lead reduction to 0.40 ppm as compared to 3.80 ppm when phosphoric acid was added to the flyash-scrubber ash prior to water. Similar results were produced for reversing water and TSP addition sequence.

TABLE 3

| Stabilizer Dose (%) | TCLP Pb Total/Soluble (ppm) |
|---|---|
| 0 | 55 |
| 100 H + 24 hr | 20 |
| 10 TSP + 50 H + 24 hr | 12 |
| 15 TSP + 50 H + 24 hr | 6.40 |
| 50 H + 15 TSP + 24 hr | 0.40 |
| 20 TSP + 50 H + 24 hr | 3.2 |
| 100 H + 15 TSP + 15 PC + 24 hr | 0.05/0.05 |
| 100 H + 15 WA + 15 PC + 24 hr | 0.05/0.05 |
| 10 WA + 100 H + 24 hr | 3.80 |
| 100 H + 10 WA + 24 hr | 0.40 |

The foregoing results in Table 1 and Table 2 readily established the operability of the present process to stabilize and agglomerate heavy metal bearing wastes and the benefit of pre-hydration, thus providing for a more efficient means of reducing leachability, fugitivity and bioavailability. Given the effectiveness of the water pre-hydration followed by stabilizing and agglomerating agents in causing heavy metals to stabilize and agglomerate as presented in the Table 1, it is believed that an amount of the water from 50% to 100% dwb and agents equivalent to less than 50% by weight of heavy metal bearing material or waste should be effective. It is also apparent from the Table 1 and Table 2 results that certain water hydration sequencing and stabilizing and agglomeration agents and blends are more or less effective.

While this invention has been particularly shown and described with reference to preferred embodiments thereof, it will be understood by those skilled in the art that various changes in form and details may be made therein without departing from the spirit and scope of the invention as defined by the appended claims.

1. A method of reducing the solubility and mobility of heavy metal bearing material or waste, comprising contacting heavy metal bearing material or waste with at least one water source, one stabilizing agent, one agglomerating agent, or combinations thereof in an amount effective in reducing the leaching of heavy metals from the material or waste to a level no more than non-hazardous levels as determined in an EPA TCLP test, performed on the stabilized material or waste, as set forth in the Federal Register, vol. 55, no. 126, pp. 26985-26998 (Jun. 29, 1990), and reducing particulate mobility as measured by visual fugitive dust potential.

2. The method of claim 1, wherein the stabilizing or agglomerating agent is selected from the group consisting of water, phosphates, natural phosphates, engineered phosphates, sulfates, sulfides, Portland cement, silicates, cement kiln dust, lime kiln dust, lime, iron, polymer, dolomitic lime, ferrous sulfate, ferric sulfate, sodium sulfide, sodium silicate, magnesium oxide, ferric chloride and mineral complexing agent combinations, wet process amber phosphoric acid, wet process green phosphoric acid, coproduct phosphoric acid solution from aluminum polishing, technical grade phosphoric acid, hexametaphosphate, polyphosphate, calcium orthophosphate, superphosphates, triple superphosphates, phosphate fertilizers, phosphate rock, bone phosphate, fishbone phosphates, tetrapotassium polyphosphate, monocalcium phosphate, monoammonia phosphate, diammonium phosphate, dicalcium phosphate, tricalcium phosphate, trisodium phosphate, salts of phosphoric acid, and combinations thereof.

3. The method of claim 1, wherein the water is provided from potable source, process water, rainwater, river water, lake water, pond water, salt water, brackish water.

4. The method of claim 1 wherein material or waste is contacted with at least one water, one stabilizing agent, one agglomeration agent or combinations thereof in effective amount to reduce leaching to TCLP non-hazardous or desired levels prior to collection of such material or waste in containers.

5. The method of claim 1 wherein material or waste is contacted with at least one water, one stabilizing agent, one agglomeration agent, or combinations thereof in effective amount to reduce leaching to TCLP non-hazardous or desired levels during or after collection of such material or waste in containers or during or after generation of a regulated waste.

6. A method of claim 1 wherein reduction of solubility of heavy metal bearing material or waste, comprising contacting heavy metal bearing material or waste with at least one water, one stabilizing agent, one agglomeration agent, or combinations thereof in an amount effective in reducing the leaching of heavy metals from the material or waste to a level no more than non-hazardous levels as determined under leach tests required by regulation in countries other than the USA including but not limited to Switzerland, Mexico, Taiwan, Japan, Thailand, China, Canada, Germany.

7. The method of claim 1 wherein material or waste includes refuse incinerator flyash, incinerator scrubber residue, incinerator slag, incinerator bottom ash, sludge, sediments, tank bottoms, smelter ash, auto shredder fluff, wire chopper fluff, manhole sediment, foundry sands and dusts, paint residue, paint blast residue, and contaminated soils.
